(19) United States
(12) Patent Application Publication
(10) Pub. No.: US 2012/0328500 A1
(43) Pub. Date: Dec. 27, 2012

(54) HIGHLY ACIDIC COMPOSITIONS COMPRISING ZIRCONIUM AND SILICON OXIDES AND AN OXIDE OF AT LEAST ONE OTHER ELEMENT SELECTED FROM AMONG TITANIUM, ALUMINUM, TUNGSTEN, MOLYBDENUM, CERIUM, IRON, TIN, ZINC, AND MANGANESE

(75) Inventors: Olivier LARCHER, Perigny (FR); Emmanuel ROHART, Sainte Soulle (FR); Stephan VERDIER, Lyon (FR); Heather BRADSHAW, Manchester (GB); Clive BUTLER, Manchester (GB); Deborah HARRIS, Manchester (GB); Mairead FEELEY, Manchester (GB); Guillaume CRINIERE, Ixelles (BE)

(73) Assignees: MAGNESIUM ELEKTRON LIMITED, Manchester (GB); RHODIA OPERATIONS, Aubervilliers (FR)

(21) Appl. No.: 13/604,560

(22) Filed: Sep. 5, 2012

Related U.S. Application Data
(62) Division of application No. 12/446,201, filed on May 19, 2010, now abandoned.

(30) Foreign Application Priority Data
Oct. 20, 2006 (FR) 06 09224

(51) Int. Cl. B01D 53/94

(52) U.S. Cl. 423/213.5; 423/213.2

(57) ABSTRACT

Compositions useful for treating the exhaust gases of diesel engines contain zirconium oxide, silicon oxide and at least one oxide of at least one element M selected from among titanium, aluminum, tungsten, molybdenum, cerium, iron, tin, zinc, and manganese, in the following mass proportions of these different elements: silicon oxide: 5%-30%; M-element oxide: 1%-20%; the balance being zirconium oxide; such compositions also have an acidity, as measured by the methylbutynol test, of at least 90% and are prepared by placing a zirconium compound, a silicon compound, at least one M-element compound and a basic compound in a liquid medium, thereby generating a precipitate, maturing the precipitate in a liquid medium and separating and calcining the precipitate.

### CROSS-REFERENCE TO EARLIER APPLICATIONS

This application is a divisional of copending U.S. patent application Ser. No. 12/446,201, filed May 19, 2010, which is the national stage of PCT/EP2007/061233, filed Oct. 19, 2007, and designating the United States (published in French on Apr. 28, 2008 as WO 2008/046920 A1; the title and abstract were published in English), which claims priority to French Application No. 06 09224, filed in France on Oct. 20, 2006, each earlier application hereby expressly incorporated by reference in its entirety and each assigned to the assignee hereof.

The present invention relates to a composition of high acidity based on zirconium oxide, on silicon oxide and on at least one oxide of another element M chosen from titanium, aluminium, tungsten, molybdenum, cerium, iron, tin, zinc and manganese, to processes for the preparation of this composition and to its use in the treatment of exhaust gases from diesel engines.

It is known to use, in the treatment of exhaust gases from diesel engines, oxidating catalysts which have the effect of catalysing the oxidation of carbon monoxide (CO) and hydrocarbons (HC) present in these gases. In point of fact, new diesel engines produce gases which have a greater content of CO and HC than older engines. Furthermore, due to the hardening of antipollution standards, the exhaust systems of diesel engines will, in future, have to be equipped with particle filters. In point of fact, the catalysts are also used to raise the temperature of the exhaust gases to a value sufficiently high to trigger the regeneration of these filters. It is thus understood that there is a need for catalysts having an improved effectiveness, since they have to treat gases with a greater content of pollutants, and having a temperature stability which is also enhanced, since these catalysts risk being subjected to higher temperatures during the regeneration of the filters.

It is also known that, in the case of the treatment of the gases from diesel engines by reduction of the nitrogen oxides (NOx) by ammonia or urea, it is necessary to have catalysts exhibiting a degree of acidity and, here again, a degree of temperature stability.

Finally, it is known that there is also a need for catalysts having performances relatively insensitive to sulphation.

The object of the invention is to provide materials capable of being used in the manufacture of catalysts meeting these needs.

For this purpose, the composition according to the invention is based on zirconium oxide, on silicon oxide and on at least one oxide of another element M chosen from titanium, aluminium, tungsten, molybdenum, cerium, iron, tin, zinc and manganese and in the following proportions by weight of these various elements:
silicon oxide: 5%-30%
oxide of the element M: 1%-20%

the remainder to 100% of zirconium oxide,

and it is characterized in that it additionally exhibits an acidity, measured by the methylbutynol test, of at least 90%.

Due to its acidity, the composition of the invention confers a good catalytic activity on the catalysts in the manufacture of which it is used.

Furthermore, the composition of the invention has the advantage of exhibiting a specific surface which varies relatively little after ageing, that is to say after having been subjected to high temperatures.

Finally, and as another advantage, the composition of the invention exhibits an improved resistance to sulphation.

Other characteristics, details and advantages of the invention will become even more fully apparent on reading the description which will follow and various concrete but non-limiting examples intended to illustrate it.

For the continuation of the description, the term “specific surface” is understood to mean the BET specific surface determined by nitrogen adsorption in accordance with Standard ASTM D 3663-78, drawn up from the Brunauer-Emmett-Teller method described in the periodical “The Journal of the American Chemical Society, 60, 309 (1938)”.

The term “rare earth metal” is understood to mean the elements of the group consisting of yttrium and the elements of the Periodic Table with an atomic number of between 57 and 71 inclusive.

The Periodic Table of the Elements to which reference is made is that published in the supplement to the Bulletin de la Société Chimique de France, No. 1 (January 1966).

Additionally, the calcinations at the conclusion of which the surface values are given are calcinations under air.

The specific surface values which are shown for a given temperature and a given period of time correspond, unless otherwise indicated, to calcinations under air at a stationary temperature over the period of time shown.

The contents are given by weight and as oxide, unless otherwise indicated.

It is also specified that, for the continuation of the description, unless otherwise indicated, in the ranges of values which are given, the values at the limits are included.

The compositions according to the invention are characterized first by the nature of their constituents.

These compositions are based on zirconium oxide, it being possible for the content of zirconium oxide to be more particularly between 70% and 90% and more particularly still between 75% and 85%. They additionally comprise silica in a proportion of between 5% and 30%, more particularly between 5% and 15% and more particularly still between 10% and 15%. They furthermore comprise at least one oxide of a third element chosen from titanium, aluminium, tungsten, molybdenum, cerium, iron, tin, zinc and manganese in a proportion of between 1% and 20%, more particularly between 5% and 15%.

The compositions of the invention can be provided in the form of several alternative forms as regards their composition.

According to a specific alternative form, these compositions are essentially composed of zirconium oxide, of silicon oxide and of tungsten oxide. In this case, they do not comprise an oxide of another element M or of another metal of precious metal type, in particular.

According to another alternative form, the compositions of the invention are based on or are composed essentially of zirconium oxide, silicon oxide and oxides of cerium and of manganese.

According to yet another alternative form, the compositions of the invention can additionally comprise at least one oxide of a fourth element M′ chosen from the rare earth metals other than cerium. This rare earth metal can very particularly be yttrium or lanthanum. The content of this rare earth metal is generally between 1 and 15% by weight, more particularly between 1 and 10% by weight.

Mention may more particularly be made, as examples of compositions of this type, of compositions based on zirconium oxide, on silicon oxide and on oxides of yttrium and of tungsten, and also compositions based on zirconium oxide, on silicon oxide and on oxides of cerium, of tungsten and of yttrium, compositions based on zirconium oxide, on silicon oxide and on oxides of iron and of yttrium, compositions based on zirconium oxide, on silicon oxide and on oxides of tungsten, of manganese and of yttrium or compositions based on zirconium oxide, on silicon oxide and on oxides of tungsten, of manganese, of yttrium and of cerium.

An important characteristic of the compositions of the invention is their acidity. This acidity is measured by the methylbutynol test, which will be described later, and it is at least 90% and more particularly it can be at least 95%.

This acidity can also be evaluated by the acidic activity, which is also measured from the methylbutynol test and which characterizes an acidity of the product independently of its surface.

This acidic activity is at least 0.03 mmol/h/m², more particularly at least 0.05 mmol/h/m². It can more particularly still be at least 0.075 mmol/h/m² and in particular at least 0.09 mmol/h/m².

The compositions of the invention exhibit a high specific surface. This is because the surface can be at least 65 m²/g after calcination at 900° C. for 4 hours, in the case of the compositions for which the element M is tungsten. In the other cases, that is to say when the element M is other than tungsten, this surface is at least 95 m²/g after calcination, still at 900° C. for 4 hours. This surface, measured under the same conditions, can more particularly be at least 100 m²/g and more particularly still at least 110 m²/g, in particular when the element M is titanium or aluminium. In the specific case of aluminium, this surface can more particularly still be at least 130 m²/g.

Furthermore, the compositions of the invention can exhibit a still high surface at a higher temperature. Thus, after calcination at 1000° C. for 4 hours, they can have a specific surface of at least 10 m²/g, it being possible for this surface to more particularly be at least 15 m²/g and more particularly still at least 20 m²/g, in particular in the case where the element M is aluminium or cerium.

According to an advantageous alternative form, the compositions of the invention can be provided in the form of a solid solution, even after calcination at 900° C. for 4 hours or at 1000° C. for 4 hours. This is understood to mean that the elements silicon and M are in solid solution in the zirconium oxide. This characteristic can be demonstrated by an X-ray analysis of the composition. The X-ray diagrams in this case do not reveal peaks corresponding to silica or to an oxide of the element M. These diagrams show only the presence of zirconium oxide, generally in a single tetragonal phase. However, the presence of two zirconium oxide phases, a predominant tetragonal phase and another minor monoclinic phase, is sometimes possible.

The compositions of the invention can additionally exhibit a sulphate content which can be very low. This content can be at most 800 ppm, more particularly at most 500 ppm, more particularly still at most 100 ppm, this content being expressed as weight of SO₄ with respect to the whole of the composition. This content is measured with a device of Leco or Eltra type, that is to say by a technique employing a catalytic oxidation of the product in an induction furnace and an IR analysis of the SO₂ formed.

Furthermore, the compositions of the invention can also exhibit a chlorine content which can be very low. This content can be at most 500 ppm, in particular at most 200 ppm, more specifically at most 100 ppm, more particularly at most 50 ppm and more particularly still at most 10 ppm, this content being expressed as weight of Cl with respect to the whole of the composition.

Finally, the compositions of the invention can also exhibit a content of alkali metal element, in particular of sodium, of at most 500 ppm, in particular of at most 200 ppm, more particularly of at most 100 ppm, more particularly still of at most 50 ppm, this content being expressed as weight of element, for example weight of Na, with respect to the whole of the composition.

These contents of chlorine and alkali metal are measured by the ion chromatography technique.

The processes for the preparation of the compositions of the invention will now be described. This is because there exist two possible embodiments for this preparation, each embodiment being able to comprise alternative forms.

The two embodiments can be distinguished by in particular the nature of the starting zirconium compound and the alternative forms by the stage of introduction of the compounds of the element M.

The process according to the first embodiment is characterized in that it comprises the following stages:
(a₁) a zirconium compound, a silicon compound, a compound of the element M and a basic compound are brought into contact in a liquid medium, whereby a precipitate is obtained;
(b₁) the precipitate thus obtained is matured in a liquid medium;
(c₁) the precipitate is separated from the medium resulting from the preceding stage and is calcined.

The process according to this first embodiment comprises an alternative form in which the first stage consists in bringing into contact, in the liquid medium, a zirconium compound, a basic compound and a silicon compound but without the compound of the element M. This alternative form subsequently employs a stage (b₁′) identical to the stage (b₁) of the preceding alternative form. Subsequently, in a stage (c₁′), a compound of the element M is added to the medium resulting from the preceding stage. It should be noted that it is possible to carry out this stage (c₁′) by first of all separating the precipitate from the medium obtained following the maturing of the stage (b₁′), by washing the separated precipitate, by then resuspending it in water and by adding the element M to the suspension obtained. It should be noted that, in the specific case of tungsten, it may be preferable to adjust the pH of the medium to a value of between 3 and 9 before introduction of the compound of the element M.

In a following stage (d₁′), the suspension is dried, this drying being carried out more particularly by atomization.

The term “drying by atomization” is understood to mean conventionally, here and for the remainder of the description, drying by spraying the suspension in a hot atmosphere (spray drying). The atomization can be carried out by means of any sprayer known per se, for example by a spray nozzle of the shower head or other type. Use may also be made of “rotary” atomizers. Reference may in particular be made, with regard to the various spraying techniques capable of being employed in the present process, to the reference work by Masters entitled “Spray Drying” (second edition, 1976, published by George Godwin, London).

Finally, in a last stage (e₁′), the precipitate obtained after the atomization is calcined.

The various stages above will be described in more detail.

The first stage of the process according to this first embodiment consists in bringing into contact, in the liquid medium, a zirconium compound, a silicon compound and, in the case of the first alternative form, a compound of the element M. The various compounds are present in the stoichiometric proportions necessary to obtain the final composition desired.

The liquid medium is generally water.

The compounds are preferably soluble compounds. The zirconium compound can preferably be a nitrate which may have been obtained, for example, by attack by nitric acid on a zirconium hydroxide.

Mention may more particularly be made, as silicon compound, of alkali metal silicates and in particular sodium silicate. The silicon can also be contributed by a compound of the silica sol type, such as, for example, Morrisol or Ludox, sold respectively by Morrisons Gas Related Products Limited and Grace Davison, or also by an organometallic compound, such as sodium tetraethyl orthosilicate (TEOS), potassium methyl siliconate or the like.

The compound of the element M can be chosen for example from ammonium titanyl oxalate (NH₄)₂TiO(ox)₂, titanium oxychloride TiOCl₂, aluminium nitrate Al(NO₃)₃, aluminium chlorohydrate Al₂(OH)₅Cl, boehmite AlO(OH), ammonium metatungstate (NH₄)₆W₁₂O₄₁ and sodium metatungstate Na₂WO₄, ammonium heptamolybdate (NH₄)₆Mo₇O₂₄.4H₂O.

In the case of cerium and the other rare earth metals, iron, tin, zinc and manganese, use may be made of inorganic or organic salts of these elements. Mention may be made of the chlorides or the acetates and more particularly the nitrates. Mention may even more particularly be made of tin(II) or (IV) chloride or zinc nitrate.

Use may be made, as basic compound, of the products of hydroxide or carbonate type. Mention may be made of alkali metal or alkaline earth metal hydroxides and ammonia. Use may also be made of secondary, tertiary or quaternary amines. Mention may also be made of urea.

The various compounds can be brought into contact in various ways. The compound of the element M can be introduced with the zirconium compound into a reactor containing, as vessel heel, the basic compound and then, in a second step, the silicon compound can be added.

It is also possible to simultaneously introduce the compound of the element M, the zirconium compound and the silicon compound into a reactor containing, as vessel heel, the basic compound.

This first stage is generally carried out at ambient temperature (15-35° C.).

The second stage (b₁) or (b₁′) of the process according to the first embodiment is the maturing stage. This can be carried out directly on the reaction medium obtained after the stage (a₁) or (a₁′) or, optionally, on a suspension obtained after separation of the precipitate from the medium resulting from the stage (a₁) or (a₁′) and resuspension of the precipitate in water. The maturing is carried out by heating the medium. The temperature to which the medium is heated is at least 60° C. and more particularly still at least 90° C. The medium is thus maintained at a constant temperature for a period of time which is usually at least 30 minutes and more particularly at least 1 hour. The maturing can be carried out at atmospheric pressure or, optionally, at a higher pressure.

On conclusion of the maturing stage, a mass of a solid precipitate is recovered and can be separated from its medium by any conventional solid/liquid separation technique, such as, for example, filtration, separation by settling, spinning or centrifuging.

Preferably, the product as recovered is subjected to one or more washing operations, with water or with acidic or basic aqueous solutions.

In the case of the second alternative form, the precipitate obtained, preferably after washing under the conditions which have just been described, is resuspended in water and the compound of the element M is added to the suspension thus obtained. Here again and in the specific case of tungsten, it may be preferable to adjust the pH of the medium to a value of between 3 and 9 before introducing the compound of the element M.

That which was described above as examples of such a compound also applies here.

In a following stage of this alternative form, this suspension is dried. The drying operation can be carried out by any known means, for example at a temperature of between 50° C. and 200° C. It can be carried out more particularly by atomization or by lyophilization.

The final stage of the process is a calcination. This calcination makes it possible to develop the crystallinity of the product formed and it can also be adjusted according to the subsequent operating temperature reserved for the composition, this being done while taking into account the fact that the specific surface of the product decreases as the calcination temperature employed increases. Such a calcination is generally carried out under air.

In practice, the calcination temperature is generally limited to a range of values of between 500° C. and 1000° C., more particularly between 700° C. and 900° C.

The period of time for this calcination can vary within wide limits; in principle, it increases as the temperature decreases. Solely by way of example, this period of time can vary between 2 hours and 10 hours.

In the case of the preparation of a composition comprising two elements M, it is possible to use a process according to the alternative form described above in which, however, a compound of the first element M is introduced in the first stage with the zirconium compound and the silicon compound, the compound of the second element M being subsequently introduced during the stage (c₁′). For the compositions comprising an element M′, it is possible to proceed in the same way, the compound of the element M′ being introduced either in the first stage or in the stage (c₁′).

A second embodiment of the preparation process will now be described.

The process according to the second embodiment is characterized in that it comprises the following stages:
(a₂) a zirconium oxychloride, a compound of the element M and a basic compound, so as to bring the pH of the medium formed to a value of at least 12, are brought into contact in a liquid medium, whereby a precipitate is obtained;
(b₂) the medium obtained in the preceding stage is optionally matured;
(c₂) a silicon compound and an acid, so as to bring the pH of the medium formed to a value of between 4 and 8, are added to the medium obtained in the stage (a₂) or (b₂), if the latter is carried out;
(d₂) the precipitate is separated from the medium resulting from the stage (c₂) and is calcined.

The process according to this second embodiment also comprises an alternative form in which the first stage consists in bringing into contact, in a liquid medium, a zirconium oxychloride and a basic compound but without the compound of the element M. This alternative form subsequently employs stages (b₂′), the latter also being optional, and (c₂′), which are respectively identical to the stages (b₂) and (c₂) of the preceding alternative form. Subsequently, in a stage (d₂′), the precipitate is separated from the medium resulting from the stage (c₂′), the precipitate is resuspended in water and a compound of the element M is added to the suspension obtained. Then, in a stage (e₂′), the suspension is dried, more particularly by atomization or lyophilization, and, in a final stage, the product obtained is calcined.

That which was described above for the first embodiment for the first stage, in particular with regard to the nature of the various compounds, the bringing into contact of the compounds and their order of introduction, and the precipitation, also applies here. However, the second embodiment can be distinguished, first by the nature of the zirconium compound since in this instance it is an oxychloride which may have been obtained, for example, by attack of hydrochloric acid on a zirconium hydroxide. In addition, in the case of the second embodiment, the precipitation is carried out at a pH which has to be at least 12. For this reason, it is preferable to use a basic compound with a basicity sufficiently high to establish this condition. Use is thus preferably made of an alkali metal hydroxide, such as sodium hydroxide or potassium hydroxide.

It is possible, at this stage of the process, to use additives liable to facilitate the use of the process, such as sulphates, phosphates or polycarboxylates.

On conclusion of this first stage, a maturing of the same type as that described above for the first embodiment can be carried out, as well as, preferably, a washing operation. That which was described in the case of this first embodiment for the maturing and washing conditions also applies here.

The process according to the second embodiment comprises a third stage, (c₂) or (c₂′) according to the alternative form concerned, in which the alkali metal silicate or the silica sol and an acid are added to the medium resulting from the preceding stage (a₂) or (b₂) or (a₂′) or (b₂′). Generally, this third stage is carried out after an intermediate washing operation, that is to say after resuspending the precipitate, washed beforehand, in water.

The addition of the silicon compound and the acid is carried out under conditions such that the pH of the medium thus obtained is between 4 and 8.

Use is made, as acid, of nitric acid, for example.

It is possible, on conclusion of the stages (c₂) or (c₂′) and before the separation of the precipitate from the liquid medium, to carry out a maturing. This maturing is carried out under the same conditions as those described above.

The final stage (d₂) of the process, in the case of the first alternative form, consists in separating the precipitate from the medium obtained on conclusion of the preceding stage and in calcining it, optionally after a washing operation. This separation, the optional washing operation and the calcination are carried out under the same conditions as those which were defined above in the analogous stages of the first embodiment.

In the case of the alternative form where the compound of the element M was not introduced during the first stage, the procedure is as was indicated above, by separation of the precipitate, resuspending, addition of the compound of the element M and drying, more particularly by atomization or lyophilization. It should be noted that, in the specific case of tungsten, it may be preferable to adjust the pH of the medium to a value of between 3 and 6, preferably between 3 and 4, before introduction of the compound of the element M.

The process according to the second embodiment of the invention can be carried out according to yet another alternative form. According to this alternative form, the process comprises the following stages:
(a₂″) a zirconium oxychloride and a basic compound, so as to bring the pH of the medium formed to a value of at least 12, are brought into contact in a liquid medium, whereby a precipitate is obtained;
(b₂″) the medium obtained in the preceding stage is optionally matured;
(c₂″) a silicon compound and a compound of the element M and an acid, so as to bring the pH of the medium formed to a value of between 4 and 8, are added to the medium obtained in the stage (a₂″) or (b₂″);
(d₂″) the solid is separated from the medium resulting from the stage (c₂″) and is calcined.

As is seen, this alternative form comprises two first stages (a₂″) and (b₂″) which are identical to the corresponding stages of the alternative form described above in which the compound of the element M is not present in the first stage. Very clearly, everything which was described above for these stages likewise applies here for the description of this alternative form. The difference from the preceding alternative form lies in the fact that the silicon compound and the compound of the element M are brought into contact together in the stage (c₂″). The conditions under which this stage and the following stage take place are furthermore identical to that which was described for the stages of the same type of the other alternative forms. It is likewise possible to provide a maturing on conclusion of the stage (c₂″).

In the more particular case of the compositions comprising at least two elements M, the process according to the second embodiment of the invention can be carried out according to a specific alternative form. According to this last alternative form, the process comprises the following stages:
(a₃) a zirconium oxychloride, a compound of a first element M and a basic compound, so as to bring the pH of the medium formed to a value of at least 12, are brought into contact in a liquid medium, whereby a precipitate is obtained;
(b₃) the medium obtained in the preceding stage is optionally matured;
(c₃) a silicon compound and a compound of a second element M and an acid, so as to bring the pH of the medium formed to a value of between 4 and 8, are added to the medium obtained in the stage (a₃) or (b₃);
(d₃) the solid is separated from the medium resulting from the stage (c₃) and is calcined.

Still in the more particular case of the compositions comprising at least two elements M, the process according to the second embodiment of the invention can be carried out according to yet another specific alternative form. According to this alternative form, the process then comprises the following stages:
(a₄) a zirconium oxychloride and a basic compound, so as to bring the pH of the medium formed to a value of at least 12, are brought into contact in a liquid medium, whereby a precipitate is obtained;
(b₄) the medium obtained in the preceding stage is optionally matured;
(c₄) a silicon compound, a compound of at least one of the elements M and an acid, so as to bring the pH of the medium formed to a value of between 4 and 8, are added to the medium obtained in the stage (a₄) or (b₄);
(d₄) the precipitate is separated from the medium resulting from the stage (c₄) and is resuspended in water, and a compound of at least one other element M is added to the suspension obtained;
(e₄) the suspension is dried, more particularly by atomization or lyophilization;
(f₄) the product resulting from the stage (e₄) is calcined.

Finally, in the even more particular case of the compositions comprising at least one element M′, the latter can be introduced in the form of a compound of this element in the same way as the compound of the element M in one of the abovementioned stages (a₁′), (a₂), (c₂), (a₂′), (c₂′), (d₂′), (a₂″), (c₂″), (a₃), (c₃), (a₄) or (c₄).

As is seen, these alternative forms are characterized essentially by the order of introduction of the constituent elements of the compositions, in particular of the elements M or M′, but the conditions for carrying out each of the stages are identical to that which was described for the corresponding or analogous stages of the preceding alternative forms. It will be specified here simply that, on conclusion of the stage (c₃) or (c₄) and before the separation of the precipitate, it is also possible to mature the precipitate or the solid in a liquid medium.

Finally, mention may be made of another alternative form which applies to both embodiments of the process and for the case where the element M is introduced during the first stage or alternatively on conclusion of the stages (c₂″), (c₃) or (c₄). In this last alternative form, the precipitate is dried, preferably by atomization, before the final calcination stage.

Finally, the use of an alkali metal silicate is preferred when it is desired to obtain compositions in the form of a solid solution.

The compositions of the invention as described above or as obtained by the processes mentioned above are provided in the form of powders but they can optionally be shaped in order to be provided in the form of granules, beads, cylinders, monoliths or filters in the form of honeycombs of variable dimensions. These compositions can be applied to any support commonly used in the field of catalysis, that is to say in particular thermally inert supports. This support can be chosen from alumina, titanium oxide, cerium oxide, zirconium oxide, silica, spinels, zeolites, silicates, crystalline silicoaluminium phosphates or crystalline aluminium phosphates.

The compositions can also be used in catalytic systems. The invention thus also relates to catalytic systems comprising compositions of the invention. These catalytic systems can comprise a coating (wash coat), which has catalytic properties and which is based on these compositions, on a substrate of the, for example, metal monolith or ceramic monolith type. The coating can itself also comprise a support of the type of those mentioned above. This coating is obtained by mixing the composition with the support so as to form a suspension, which can subsequently be deposited on the substrate.

In the case of these uses in catalytic systems, the compositions of the invention can be employed in combination with transition metals; these thus act as support for these metals. The term “transition metals” is understood to mean the elements from Groups IIIA to IIB of the Periodic Table. Mention may more particularly be made, as transition metals, of vanadium and copper and also precious metals, such as platinum, rhodium, palladium, silver or iridium. The nature of these metals and the techniques for incorporating them in the support compositions are well known to a person skilled in the art. For example, the metals can be incorporated in the compositions by impregnation.

The systems of the invention can be used in the treatment of gases. In this case, they can act as catalyst for the oxidation of CO and hydrocarbons present in these gases or also as catalyst for the reduction of nitrogen oxides (NOx) in the reaction for the reduction of these NOx by ammonia or urea and, in this case, as catalyst for the reaction for the hydrolysis or decomposition of urea to give ammonia (SCR process). In the case of this use in SCR catalysis, the compositions based on zirconium oxide, on silicon oxide and on oxides of yttrium and of tungsten and the compositions based on zirconium oxide, on silicon oxide and on oxides of cerium, of tungsten and of yttrium are particularly advantageous.

The gases capable of being treated in the context of the present invention are, for example, those emitted by stationary installations, such as gas turbines or power station boilers. They can also be the gases resulting from internal combustion engines and very particularly the exhaust gases from diesel engines.

In the case of the use in catalysis of the reaction for the reduction of NOx by ammonia or urea, the compositions of the invention can be employed in combination with metals of the transition metal type, such as vanadium or copper.

Examples will now be given.

A description is first of all given below of the methylbutynol test used to characterize the acidity of the compositions according to the invention.

This catalytic test is described by Pernot et al. in Applied Catalysis, 1991, vol. 78, p. 213, and uses 2-methyl-3-butyn-2-ol (methylbutynol or MBOH) as probe molecule for the surface acidity/basicity of the compositions prepared. Depending on the acidity/basicity of the surface sites of the composition, the methylbutynol can be converted according to 3 reactions:

TABLE 1

| Reaction | Reaction products |
|---|---|
| Acidic | 2-methyl-1-buten-3-yne + 3-methyl-2-butenal |
| Amphoteric | 3-hydroxy-3-methyl-2-butanone + 3-methyl-3-buten-2-one |
| Basic | acetone + acetylene |

Experimentally, an amount (w) of approximately 400 mg of composition is placed in a quartz reactor. The composition is subjected first to a pretreatment at 400° C. for 2 h under an N₂ gas flow at a flow rate of 4 l/h.

The temperature of the composition is subsequently brought to 180° C. The composition is then periodically brought into contact with given amounts of MBOH. This operation of bringing into periodic contact consists in transporting, during an injection of 4 minutes, a synthetic mixture of 4% by volume of MBOH in N₂ with a flow rate of 4 l/h, which corresponds to an hourly molar flow rate of methylbutynol (Q) of 7.1 mmol/h. Ten injections are carried out. At the end of each injection, the gas stream at the reactor outlet is analysed by gas chromatography to determine the nature of the reaction products (cf. Table 1) and their amount.

The selectivity (Sᵢ) for a product i of the methylbutynol conversion reaction is defined by the proportion of this product with respect to all the products formed (Sᵢ=Cᵢ/. where Cᵢ is the amount of the product i and represents the sum of the products formed during the reaction). An acidic, amphoteric or basic selectivity is then defined which is equal to the sum of the selectivities for the products formed in the acidic, amphoteric and basic reactions respectively. For example, the acidic selectivity (S[acidic]) is equal to the sum of the selectivities for 2-methyl-1-buten-3-yne and for 3-methyl-2-butenal. Thus, the greater the acidic selectivity, the greater the amounts of acidic reaction products formed and the greater the number of acidic sites on the composition studied.

The degree of conversion of the methylbutynol (DC) during the test is calculated by taking the mean of the degrees of conversion of the methylbutynol over the final 5 injections of the test.

The acidic activity (A[acidic]) of the composition, expressed in mmol/h/m², can also be defined from the degree of conversion of the methylbutynol (DC, expressed as %), the hourly molar flow rate of the methylbutynol (Q, expressed in mmol/h), the acidic selectivity (S[acidic], expressed as %), the amount of composition analysed (w, expressed in g) and the specific surface of the composition (SBET, expressed in m²/g), according to the following relationship:

A[acidic]=10⁻⁴.DC.Q.S[acidic]/(SBET.w)

The acidity (acidic selectivity) values obtained by the test which has just been described are given in Table 2 for each of the compositions which form the subject of the examples which follow.

### EXAMPLE 1

This example relates to the preparation of a composition based on oxides of zirconium, of silicon and of tungsten in the respective proportions by weight of oxide of 80%, 10% and 10%.

A solution A is prepared by mixing, in a beaker with stirring, 50 g of an aqueous ammonia solution (32% by volume) with distilled water so as to obtain a total volume of 500 ml. At the same time, a solution B is prepared by mixing, in a beaker with stirring, 170.4 g of a zirconium nitrate solution (26% by weight, expressed as oxide) with distilled water so as to obtain a total volume of 450 ml.

The solution A is introduced into a stirred reactor and then the solution B is added gradually with stirring. The pH of the medium reaches a value of at least 9.

A solution C is prepared, in a beaker with stirring, by mixing 28 g of sodium silicate (19% by weight, expressed as oxide) with distilled water so as to obtain a total volume of 50 ml. The solution C is gradually introduced into the stirred reactor.

The suspension thus obtained is placed in a stainless steel reactor equipped with a stirrer. The temperature of the medium is brought to 95° C. for 2 hours with stirring.

After returning to ambient temperature, the precipitate obtained is filtered off and washed with distilled water. The solid is resuspended in 900 ml of distilled water and the pH is adjusted to 9 with an aqueous ammonia solution. 6 g of ammonium metatungstate are dissolved in 100 ml of distilled water and then this solution is gradually added to the suspension. The medium is finally atomized on a Büchi atomizer at 110° C. (outlet temperature of the gases).

The product obtained after atomization is finally calcined under air at 900° C. for 4 hours under stationary conditions. This product is characterized by a specific surface of 77 m²/g and a pure tetragonal phase. After calcination under air at 1000° C. for 4 hours under stationary conditions, the specific surface is equal to 23 m²/g.

The product does not contain any detectable amounts of chlorides and sulphates and the sodium content is less than 100 ppm.

### EXAMPLE 2

This example relates to the preparation of a composition based on oxides of zirconium, of silicon and of titanium in the respective proportions by weight of oxide of 80%, 10% and 10%. The same solutions are prepared and reacted as in Example 1 but in the following amounts: 49 g of solution A, 170.2 g of solution B and 29.3 g of solution C.

The suspension thus obtained is placed in a stainless steel reactor equipped with a stirrer. The temperature of the medium is brought to 95° C. for 2 hours with stirring.

After returning to ambient temperature, the precipitate obtained is filtered off and washed with distilled water. The solid is resuspended in 900 ml of distilled water and the pH is adjusted to 8.5 with an aqueous ammonia solution. 21.4 g of titanyl oxalate (25.7% by weight of titanium oxide) are dissolved in 100 ml of distilled water and then this solution is gradually added to the suspension. The medium is finally atomized on a Büchi atomizer at 110° C.

The product obtained after atomization is finally calcined under air at 900° C. for 4 hours under stationary conditions. This product is characterized by a specific surface of 109 m²/g and a pure tetragonal phase. After calcination under air at 1000° C. for 4 hours under stationary conditions, the specific surface is equal to 38 m²/g and the product still exists in the form of a pure tetragonal phase.

The product does not contain any detectable amounts of chlorides and sulphates and the sodium content is less than 100 ppm.

### EXAMPLE 3

This example relates to the preparation of a composition based on oxides of zirconium, of silicon and of aluminium in the respective proportions by weight of oxide of 80%, 10% and 10%.

A solution A is prepared by mixing, in a beaker with stirring, 73.5 g of an aqueous ammonia solution (11.7N) with distilled water so as to obtain a total volume of 500 ml. At the same time, a solution B is prepared by mixing, in a beaker with stirring, 153.1 g of a zirconium nitrate solution (26% by weight, expressed as oxide) and 38.7 g of aluminium nitrate with distilled water so as to obtain a total volume of 450 ml.

The solution A is introduced into a stirred reactor and then the solution B is added gradually with stirring. The pH of the medium reaches a value of at least 9.

A solution C is prepared, in a beaker with stirring, by mixing 25.5 g of sodium silicate (19% by weight, expressed as oxide) with distilled water so as to obtain a total volume of 50 ml. The solution C is gradually introduced into the stirred reactor.

The suspension thus obtained is placed in a stainless steel reactor equipped with a stirrer. The temperature of the medium is brought to 98° C. for 2 hours with stirring.

After returning to ambient temperature, the precipitate obtained is filtered off and washed with distilled water. The solid is dried at 120° C. in an oven overnight and then calcined at 900° C. for 4 hours under stationary conditions. This product is characterized by a specific surface of 118 m²/g and a pure tetragonal phase. After calcination under air at 1000° C. for 4 hours under stationary conditions, the specific surface is equal to 25 m²/g and the product still exists in the form of a pure tetragonal phase.

The product does not contain any detectable amounts of chlorides and sulphates and the sodium content is less than 100 ppm.

### EXAMPLE 4

This example relates to the preparation of a composition based on oxides of zirconium, of silicon and of cerium in the respective proportions by weight of oxide of 85%, 10% and 5%.

A solution A is prepared by mixing, in a beaker with stirring, 39 g of an aqueous ammonia solution (28% by volume) with distilled water so as to obtain a total volume of 500 ml. At the same time, a solution B is prepared by mixing, in a beaker with stirring, 162.7 g of a zirconium nitrate solution (26% by weight, expressed as oxide) with distilled water so as to obtain a total volume of 450 ml.

The solution A is introduced into a stirred reactor and then the solution B is added gradually with stirring. The pH of the medium reaches a value of at least 9.

A solution C is prepared, in a beaker with stirring, by mixing 25.5 g of sodium silicate (19% by weight, expressed as oxide) with distilled water so as to obtain a total volume of 50 ml. The solution C is gradually introduced into the stirred reactor.

The suspension thus obtained is placed in a stainless steel reactor equipped with a stirrer. The temperature of the medium is brought to 99° C. for 2 hours with stirring.

After returning to ambient temperature, the precipitate obtained is filtered off and washed with distilled water. The solid is resuspended in 900 ml of distilled water and the pH is adjusted to 9 with an aqueous ammonia solution. 7.8 g of cerium(III) nitrate (27% by weight, expressed as oxide) are added to 18 g of distilled water and then this solution is gradually added to the suspension. The medium is finally atomized on a Büchi atomizer at 110° C.

The product obtained after atomization is finally calcined under air at 900° C. for 4 hours under stationary conditions. This product is characterized by a specific surface of 107 m²/g and a pure tetragonal phase. After calcination under air at 1000° C. for 4 hours under stationary conditions, the specific surface is equal to 44 m²/g.

The product does not contain any detectable amounts of chlorides and sulphates and the sodium content is less than 100 ppm.

### EXAMPLE 5

This example relates to the preparation of a composition based on oxides of zirconium, of silicon and of tungsten in the respective proportions by weight of oxide of 80%, 10% and 10%.

A solution A is prepared by dissolving 43.2 g of sodium hydroxide in the form of pellets in distilled water so as to obtain a total volume of 500 ml. At the same time, a solution B is prepared by mixing, in a beaker with stirring, 140.5 g of zirconyl chloride (100 g/l, expressed as zirconium oxide) with distilled water so as to obtain a total volume of 500 ml.

The solution A is introduced into a stirred reactor and then the solution B is added gradually with stirring. The pH of the medium reaches a value of at least 12. The precipitate obtained is filtered off and washed at 60° C. with 2.25 l of distilled water. The solid is resuspended in 1 l of distilled water.

32.7 g of sodium silicate (19% by weight, expressed as oxide) and 8.8 g of sodium metatungstate dihydrate are introduced into the suspension with stirring. The pH is adjusted to 4 by addition of a nitric acid solution (68% by volume). The medium is brought to 60° C. for 30 min and then the precipitate is again filtered off and washed at 60° C. with 2.25 l of distilled water.

The solid is resuspended in 400 ml of distilled water before being atomized on a Büchi atomizer at 105° C. The product obtained is calcined under air at 900° C. for 4 hours under stationary conditions. This product is characterized by a specific surface of 68 m²/g and a pure tetragonal phase. After calcination under air at 1000° C. for 4 hours under stationary conditions, the specific surface is equal to 15 m²/g.

The product does not contain any detectable amounts of chlorides and sulphates and the sodium content is less than 100 ppm.

### EXAMPLE 6

This example relates to the preparation of a composition based on oxides of zirconium, of silicon, of tungsten and of yttrium in the respective proportions by weight of oxide of 71%, 10%, 10% and 9%.

A solution A is prepared by mixing, in a beaker with stirring, 222 g of zirconyl chloride (20% by weight of ZrO₂), 18 g of sulphuric acid (97% by weight) and 24 g of yttrium nitrate (391 g/l of Y₂O₃) with 93 g of distilled water.

705 g of sodium hydroxide solution (10% by weight of NaOH) are introduced into a stirred reactor and then the solution A is gradually added with stirring. The pH of the medium reaches a value of at least 12.5 by subsequently adding a sodium hydroxide solution. The precipitate obtained is filtered off and washed at 60° C. with 3 l of distilled water. The solid is resuspended in 1 l of distilled water.

33 g of sodium silicate (232 g/l of SiO₂), 8.9 g of sodium metatungstate dihydrate and 20 g of distilled water are introduced into this suspension with stirring. The pH is adjusted to 5.5 by addition of a nitric acid solution (68% by volume). The medium is brought to 60° C. for 30 min and the precipitate is again filtered off and washed at 60° C. with 3 l of distilled water.

The solid is dried overnight in an oven at 120° C. and then the product obtained is calcined under air at 900° C. for 4 hours under stationary conditions. This product is characterized by a specific surface of 96 m²/g and a pure tetragonal phase. After calcination under air at 1000° C. for 4 hours under stationary conditions, the specific surface is equal to 25 m²/g.

The product comprises 50 ppm of sodium, less than 10 ppm of chlorides and less than 120 ppm of sulphates.

### COMPARATIVE EXAMPLE 7

A gamma transition alumina sold by Condéa is impregnated with a lanthanum nitrate solution so as to obtain, after drying and calcination under air at 500° C., an alumina stabilized by 10% by weight of lanthanum oxide. The specific surface is equal to 120 m²/g.

The acidity values for the compositions which form the subject of Examples 1 to 6 are given in the following Table 2.

TABLE 2

| | Acidity | Acidic activity |
|---|---|---|
| Composition | (%) | (mmol/h/m²) |
| Ex. 1 | 97 | 0.084 |
| Ex. 2 | 99 | 0.075 |
| Ex. 3 | 99 | 0.085 |
| Ex. 4 | 99 | 0.077 |
| Ex. 5 | 96 | 0.093 |
| Ex. 6 | 97 | 0.106 |
| Comparative Ex. 7 | 25 | 0.004 |

### EXAMPLE 8

This example describes a catalytic test for the oxidation of carbon monoxide CO and of hydrocarbons HC using the compositions prepared in the preceding examples.

Preparation of the Catalytic Compositions

The compositions prepared in the preceding examples are impregnated with a tetraammineplatinum(II) hydroxide salt (Pt(NH₃)₄(OH)₂) so as to obtain a catalytic composition comprising 1% by weight of platinum with respect to the weight of oxides.

The catalytic compositions obtained are dried at 120° C. overnight and then calcined at 500° C. under air for 2 h. They are subsequently subjected to ageing before the catalytic test.

Ageing

In a first step, a synthetic gas mixture comprising 10% by volume of O₂ and 10% by volume of H₂O in N₂ is transported continuously over 400 mg of catalytic composition in a quartz reactor containing the catalytic compound. The temperature of the reactor is brought to 750° C. for 16 hours under stationary conditions. The temperature subsequently returns to ambient temperature.

In a second step, a synthetic gas mixture comprising 20 vpm of SO₂, 10% by volume of O₂ and 10% by volume of H₂O in N₂ is transported continuously in a quartz reactor containing the catalytic compound. The temperature of the reactor is brought to 300° C. for 12 hours under stationary conditions.

The content of the element sulphur S in the catalytic composition is measured on conclusion of the ageing in order to evaluate its resistance to sulphation. Under the conditions of the ageing, the maximum content of sulphur which can be captured by the catalytic composition is 1.28% by weight. The lower the sulphur content of the catalytic composition after the ageing, the greater its resistance to sulphation.

The aged catalytic compositions are subsequently evaluated in a catalytic test of initiation by temperature (of light-off type) for the reactions for the oxidation of CO, propane C₃H₈ and propene C₃H₆.

Catalytic Test

In this test, a synthetic mixture representative of a diesel engine exhaust gas, comprising 2000 vpm of CO, 667 vpm of H₂, 250 vpm of C₃H₆, 250 vpm of C₃H₈, 150 vpm of NO, 10% by volume of CO₂, 13% by volume of O₂ and 10% by volume of H₂O in N₂, is passed over the catalytic composition. The gas mixture is transported continuously with a flow rate of 30 l/h in a quartz reactor containing 20 mg of catalytic compound diluted in 180 mg of silicon carbide SiC.

The SiC is inert with regard to the oxidation reactions and acts here as diluent, making it possible to ensure that the catalytic bed is homogeneous.

During a test of light-off type, the conversion of the CO, the propane C₃H₈ and the propene C₃H₆ is measured as a function of the catalytic composition. The catalytic composition is thus subjected to a temperature gradient of 10° C./min between 100° C. and 450° C. while the synthetic mixture is transported in the reactor. The gases exiting from the reactor are analysed by infrared spectroscopy at intervals of approximately 10 s in order to measure the conversion of the CO and hydrocarbons to give CO₂ and H₂O.

The results are expressed in T10% and T50%, temperatures at which 10% and 50% conversion respectively of the CO or propene C₃H₆ are measured.

Two temperature gradients are linked together. The catalytic activity of the catalytic composition is stabilized during the first gradient. The temperatures T10% and T50% are measured during the second gradient.

The results obtained after ageing are given below.

TABLE 3
(Stability of the surfaces to ageing)

| | | | Variation in the |
|---|---|---|---|
| | SBET catalyst | SBET catalyst after | BET surface |
| | before ageing | ageing | before/after ageing |
| Composition | (m²/g) | (m²/g) | (%) |
| Ex. 1 | 77 | 73 | 5 |
| Ex. 2 | 109 | 101 | 7 |
| Ex. 3 | 118 | 111 | 6 |
| Ex. 4 | 107 | 98 | 8 |
| Ex. 5 | 68 | 65 | 4 |
| Ex. 6 | 90 | 85 | 5 |
| Comparative | 120 | 80 | 33 |
| Ex. 7 | | | |

TABLE 4
(resistance to sulphation)

| | S content |
|---|---|
| Composition | (% by weight) |
| Ex. 1 | 0.28 |
| Ex. 2 | 0.32 |
| Ex. 3 | 0.60 |
| Ex. 4 | 0.44 |
| Ex. 5 | 0.26 |
| Ex. 6 | 0.56 |
| Comparative Ex. 7 | 0.97 |

TABLE 5
(T10/T50 after sulphation)

| | T10%/T50% CO | T10%/T50% C₃H₆ |
|---|---|---|
| Composition | (° C.) | (° C.) |
| Ex. 1 | 205/225 | 220/230 |
| Ex. 2 | 215/245 | 230/250 |
| Ex. 3 | 220/240 | 230/245 |
| Ex. 4 | 220/240 | 235/250 |
| Ex. 5 | 220/235 | 230/240 |
| Ex. 6 | 210/230 | 220/235 |
| Comparative | 220/245 | 235/255 |
| Ex. 7 | | |

TABLE 6
(T50% CO before and after sulphation)

| | | | Variation in the |
|---|---|---|---|
| | T50% CO (° C.) | T50% CO (° C.) | T50% before/after |
| Composition | before sulphation | after sulphation | (° C.) |
| Ex. 1 | 225 | 225 | 0 |
| Ex. 2 | 240 | 245 | +5 |
| Ex. 3 | 230 | 240 | +10 |
| Ex. 4 | 240 | 240 | 0 |
| Ex. 5 | 235 | 235 | 0 |
| Ex. 6 | 225 | 230 | +5 |
| Comparative | 220 | 245 | +30 |
| Ex. 7 | | | |

The results show that, for the compositions according to the invention, after ageing, the resistance to sulphation is improved and that the reactions for the oxidation of CO and C₃H₆ are initiated at temperatures lower than or equal to those of alumina.

It should be noted that it is highly advantageous from an industrial viewpoint to have available products with performances which remain stable before and after sulphation. This is because the products of the prior art, which vary greatly in their performance, require, during the design of the catalysts, the provision of an amount of components of these catalysts which is greater than that theoretically necessary, in order to compensate for this loss in performance. This is no longer the case for the compositions of the invention.

The results for the reaction for the oxidation of propane are given in the following table.

TABLE 7
(T10% C₃H₈ after sulphation)

| | T10% C₃H₈ (° C.) |
|---|---|
| Composition | after sulphation |
| Ex. 1 | 305 |
| Ex. 2 | 360 |
| Ex. 4 | 350 |
| Ex. 5 | 310 |
| Ex. 6 | 330 |
| Comparative | 370 |
| Ex. 7 | |

It is found, for catalysts based on the compositions of the invention, that the conversion of propane is initiated at a lower temperature than for the comparative catalyst. To obtain conversions of propane from 300° C. is likely to greatly improve the level of overall conversion of the hydrocarbons in the medium treated.

### EXAMPLE 9

This example relates to the preparation of a composition based on oxides of zirconium, of silicon, of tungsten, of yttrium and of cerium in the respective proportions by weight of oxide of 66.5%, 9.5%, 9.5%, 9.5% and 5%.

A solution A is prepared by mixing, in a beaker with stirring, 205 g of zirconyl chloride (20% by weight of ZrO₂), 17 g of sulphuric acid (97% by weight), 25 g of yttrium nitrate (391 g/l of Y₂O₃) and 11 g of cerium(III) nitrate (496 g/l of CeO₂) with 99 g of distilled water.

700 g of sodium hydroxide solution (10% by weight of NaOH) are introduced into a stirred reactor and then the solution A is gradually added with stirring. The pH of the medium reaches a value of at least 12.5 by subsequently adding a sodium hydroxide solution. 4 g of aqueous hydrogen peroxide solution (30% by volume) are introduced into the medium. After stirring for 30 min, the precipitate obtained is filtered off and washed at 60° C. with 3 l of distilled water. The solid is resuspended in 1 l of distilled water.

31 g of sodium silicate (232 g/l of SiO₂), 8.3 g of sodium metatungstate dihydrate and 19 g of distilled water are introduced into this suspension with stirring. The pH is adjusted to 5.5 by addition of a nitric acid solution (68% by volume). The medium is brought to 60° C. for 30 min and then the precipitate is again filtered off and washed at 60° C. with 3 l of distilled water.

The solid is dried overnight in an oven at 120° C. and then the product obtained is calcined under air at 900° C. for 4 hours under stationary conditions. This product is characterized by a specific surface of 75 m²/g and a pure tetragonal phase.

The product comprises 50 ppm of sodium, less than 10 ppm of chlorides and less than 120 ppm of sulphates.

### EXAMPLE 10

This example relates to the preparation of a composition based on oxides of zirconium, of silicon, of tungsten, of yttrium and of cerium in the respective proportions by weight of oxide of 66.5%, 9.5%, 9.5%, 9.5% and 5%.

A solution A is prepared by mixing, in a beaker with stirring, 219 g of zirconyl chloride (20% by weight of ZrO₂), 18 g of sulphuric acid (97% by weight) and 27 g of yttrium nitrate (391 g/l of Y₂O₃) with 93 g of distilled water.

705 g of sodium hydroxide solution (10% by weight of NaOH) are introduced into a stirred reactor and then the solution A is gradually added with stirring. The pH of the medium reaches a value of at least 12.5 by subsequently adding a sodium hydroxide solution. The precipitate obtained is filtered off and washed at 60° C. with 3 l of distilled water. The solid is resuspended in 1 l of distilled water.

33 g of sodium silicate (232 g/l of SiO₂), 8.9 g of sodium metatungstate dihydrate and 20 g of distilled water are introduced into this suspension with stirring. The pH is adjusted to 5.5 by addition of a nitric acid solution (68% by volume). The medium is brought to 60° C. for 30 min and then the precipitate is again filtered off and washed at 60° C. with 3 l of distilled water.

The solid is resuspended in 900 ml of distilled water and 11 g of cerium(III) nitrate (496 g/l of CeO₂) are added. The medium is finally atomized on a Büchi atomizer at 110° C.

The dried solid is calcined under air at 900° C. for 4 hours under stationary conditions. This product is characterized by a specific surface of 81 m²/g and a pure tetragonal phase.

The product comprises 50 ppm of sodium, less than 10 ppm of chlorides and less than 120 ppm of sulphates.

### EXAMPLE 11

This example relates to the preparation of a composition based on oxides of zirconium, of silicon, of tungsten, of yttrium and of manganese in the respective proportions by weight of oxide of 66.5%, 9.5%, 9.5%, 9.5% and 5%.

The same procedure as in Example 10 is carried out, except that 6.3 g of manganese(II) nitrate are introduced before the atomization. The dried solid is calcined under air at 700° C. for 4 hours under stationary conditions. This product is characterized by a specific surface of 90 m²/g and a pure tetragonal phase.

The product comprises 50 ppm of sodium, less than 10 ppm of chlorides and less than 120 ppm of sulphates.

The acidity values for the compositions which form the subject of Examples 9 to 11 are given in the following Table 8.

TABLE 8

| | Acidic selectivity | Acidic activity |
|---|---|---|
| Composition | (%) | (mmol/h/m²) |
| Ex. 9 | 95 | 0.063 |
| Ex. 10 | 98 | 0.121 |
| Ex. 11 | 90 | 0.051 |

### COMPARATIVE EXAMPLE 12

A ZSM5 zeolite with an SiO₂/Al₂O₃ molar ratio of 30 is exchanged with an iron acetylacetonate solution in order to obtain an Fe-ZSM5 zeolite comprising 3% by weight of iron. The product is dried overnight in an oven at 120° C. and calcined under air at 500° C. The specific surface is greater than 300 m²/g.

### EXAMPLE 13

This example describes a catalytic test for the reduction of nitrogen oxides NOx by ammonia NH₃ (NH₃—SCR) using the compositions prepared in the preceding examples.

Ageing

A synthetic gas mixture comprising 10% by volume of O₂ and 10% by volume of H₂O in N₂ is transported continuously over 400 mg of catalytic composition in a quartz reactor containing the catalytic compound. The temperature of the reactor is brought either to 750° C. for 16 hours under stationary conditions or to 900° C. for 2 hours under stationary conditions. The temperature is subsequently returned to ambient temperature.

The catalytic compositions in the fresh or aged state are subsequently evaluated in a catalytic test of conversion of NOx by selective catalytic reduction by NH₃ (SCR).

Catalytic Test

In this test, a synthetic mixture representative of the SCR application for Diesel vehicles, comprising 500 vpm of NH₃, 500 vpm of NO, 7% by volume of O₂ and 2% by volume of H₂O in He, is passed over the catalytic composition. The gas mixture is transported continuously with a flow rate of 60 ml/min in a quartz reactor containing 20 mg of catalytic compound diluted in 180 mg of silicon carbide SiC.

The SiC is inert with regard to the oxidation reactions and acts here as diluent, making it possible to ensure that the catalytic bed is homogeneous.

During a test of light-off type, the conversion of the NOx and the formation of N₂O are monitored as a function of the temperature of the catalytic composition. The catalytic composition is thus subjected to a temperature of 300° C. while the synthetic mixture is transported in the reactor. The gases exiting from the reactor are analysed by mass spectroscopy in order to monitor the concentrations of the various constituents of the gas mixture.

The results are expressed as level of conversion of NO at 300° C. and maximum concentration of N₂O formed during the test.

The results obtained after ageing are given below.

TABLE 9
(reduction of the NO by NH₃)
aged at 750° C./16 h

| | | Max. N₂O |
|---|---|---|
| | NOx conversion | concentration |
| Composition | (%) at 300° C. | (vpm) |
| Ex. 9 | 35 | 5 |
| Ex. 10 | 50 | 5 |
| Comparative | 25 | 12 |
| Ex. 12 | | |

TABLE 10
(reduction of NO by NH₃)
NO₂/NO = 0, aged at 900° C./2 h

| | | Max. N₂O |
|---|---|---|
| | NO conversion (%) | concentration |
| Composition | at 300° C. | (vpm) |
| Ex. 10 | 30 | <5 |
| Comparative | 10 | 10 |
| Ex. 12 | | |

Tables 9 and 10 show that the compositions according to the invention make it possible to obtain high NO conversions at 300° C. in the temperature range of the Diesel application while forming very little N₂O, even after severe ageing operations.

### EXAMPLE 14

This example relates to the preparation of a composition based on oxides of zirconium, of silicon, of tungsten, of yttrium and of tin in the respective proportions by weight of oxide of 63%, 9%, 9%, 9% and 10%.

A solution A is prepared by mixing, in a beaker with stirring, 192 g of zirconyl chloride (20% by weight of ZrO₂), 16 g of sulphuric acid (97% by weight), 23.5 g of yttrium nitrate (391 g/l of Y₂O₃) and 11.5 g of stannic chloride pentahydrate with 100 g of distilled water.

681 g of sodium hydroxide solution (10% by weight of NaOH) and 34 g of distilled water are introduced into a stirred reactor and then the solution A is gradually added with stirring. The pH of the medium reaches a value of at least 12.5 by subsequently adding a sodium hydroxide solution. After stirring for 30 min, the precipitate obtained is filtered off and washed at 60° C. with 3 l of distilled water. The solid is resuspended in 690 ml of distilled water.

29 g of sodium silicate (232 g/l of SiO₂), 7.8 g of sodium metatungstate dihydrate and 18 g of distilled water are introduced into this suspension with stirring. The pH is adjusted to 5.5 by addition of a nitric acid solution (68% by volume). The medium is brought to 60° C. for 30 min and then the precipitate is again filtered off and washed at 60° C. with 3 l of distilled water.

The dried solid is calcined under air at 900° C. for 4 hours under stationary conditions. This product is characterized by a specific surface of 106 m²/g and a pure tetragonal phase.

The product comprises less than 100 ppm of sodium, less than 50 ppm of chlorides and less than 120 ppm of sulphates.

### EXAMPLE 15

This example relates to the preparation of a composition based on oxides of zirconium, of silicon, of tungsten, of yttrium and of zinc in the respective proportions by weight of oxide of 69%, 10%, 10%, 10% and 1%.

A solution A is prepared by mixing, in a beaker with stirring, 212 g of zirconyl chloride (20% by weight of ZrO₂), 18 g of sulphuric acid (97% by weight) and 27 g of yttrium nitrate (391 g/l of Y₂O₃) with 93 g of distilled water.

706 g of sodium hydroxide solution (10% by weight of NaOH) are introduced into a stirred reactor and then the solution A is gradually added with stirring. The pH of the medium reaches a value of at least 12.5 by subsequently adding a sodium hydroxide solution. The precipitate obtained is filtered and washed at 60° C. with 3 l of distilled water. The solid is resuspended in 710 g of distilled water.

33 g of sodium silicate (232 g/l of SiO₂), 8.9 g of sodium metatungstate dihydrate and 20 g of distilled water are introduced into this suspension with stirring. The pH is adjusted to 5.5 by addition of a nitric acid solution (68% by volume). The medium is brought to 60° C. for 30 min and then the precipitate is again filtered off and washed at 60° C. with 3 l of distilled water.

The solid is resuspended in 900 ml of distilled water and 2.5 g of zinc nitrate (230 g/l of ZnO) are added. The medium is finally atomized on a Büchi atomizer at 110° C.

The dried solid is calcined under air at 900° C. for 4 hours under stationary conditions. This product is characterized by a specific surface of 100 m²/g and a pure tetragonal phase.

The product comprises less than 100 ppm of sodium, less than 50 ppm of chlorides and less than 120 ppm of sulphates.

### EXAMPLE 16

This example relates to the preparation of a composition based on oxides of zirconium, of silicon, of tungsten, of yttrium and of iron in the respective proportions by weight of oxide of 69%, 10%, 10%, 10% and 1%.

The same procedure is carried out as in Example 10, except that 2 g of an iron(II) nitrate solution (310 g/l of Fe₂O₃) are introduced before the atomization. The dried solid is calcined under air at 700° C. for 4 hours under stationary conditions. This product is characterized by a specific surface of 85 m²/g and a pure tetragonal phase.

The product comprises 50 ppm of sodium, less than 10 ppm of chlorides and less than 120 ppm of sulphates.

The acidity values for the compositions which form the subject of Examples 14 to 16 are given in the following Table 11.

TABLE 11

| | | Acid activity |
|---|---|---|
| Composition | Acid selectivity (%) | (mmol/h/m²) |
| Ex. 14 | 97 | 0.083 |
| Ex. 15 | 91 | 0.096 |
| Ex. 16 | 93 | 0.081 |

1. A process for the catalytic treatment of exhaust gases, said process comprising employing a catalytic system comprising zirconium oxide, silicon oxide and at least one oxide of at least one element M selected from among titanium, aluminum, tungsten, molybdenum, cerium, iron, tin, zinc and manganese in the following proportions by weight of these various elements:
silicon oxide: 5%-30%;
oxide of the element M: 1%-20%;
the remainder of zirconium oxide; and
having an acidity, measured by the methylbutynol test, of at least 90%,
for the oxidation of CO and hydrocarbons present therein.

2. The process as defined by claim 1, wherein the element M comprises tungsten and said catalytic system having a specific surface of at least 65 m²/g after calcination at 900° C. for 4 hours.

3. The process as defined by claim 1, wherein the element M is other than tungsten and said catalytic system having a specific surface of at least 95 m²/g after calcination at 900° C. for 4 hours.

4. The process as defined by claim 1, said catalytic system having a specific surface of at least 10 m²/g after calcination at 1,000° C. for 4 hours.

5. The process as defined by claim 1, said catalytic system having an acidity of at least 95%.

6. The process as defined by claim 1, said catalytic system having an acidic activity of at least 0.03 mmol/h/m².

7. The process as defined by claim 6, said catalytic system having an acidic activity of at least 0.075 mmol/h/m².

8. The process as defined by claim 1, further comprising at least one oxide of a fourth element M′ selected from among the rare earth metals other than cerium.

9. A process for the catalytic treatment of the exhaust gases from a diesel engine, said process comprising employing a catalytic system comprising zirconium oxide, silicon oxide and at least one oxide of at least one element M selected from among titanium, aluminum, tungsten, molybdenum, cerium, iron, tin, zinc and manganese in the following proportions by weight of these various elements:
silicon oxide: 5%-30%;
oxide of the element M: 1%-20%;
the remainder of zirconium oxide; and
having an acidity, measured by the methylbutynol test, of at least 90%
for the reduction of nitrogen oxides (NOx) in the reaction for the reduction of these NOx by ammonia or urea.

10. The process as defined by claim 9, wherein the element M comprises tungsten and said catalytic system having a specific surface of at least 65 m²/g after calcination at 900° C. for 4 hours.

11. The process as defined by claim 9, wherein the element M is other than tungsten and said catalytic system having a specific surface of at least 95 m²/g after calcination at 900° C. for 4 hours.

12. The process as defined by claim 9, said catalytic system having a specific surface of at least 10 m²/g after calcination at 1,000° C. for 4 hours.

13. The process as defined by claim 9, said catalytic system having an acidity of at least 95%.

14. The process as defined by claim 9, said catalytic system having an acidic activity of at least 0.03 mmol/h/m².

15. The process as defined by claim 14, said catalytic system having an acidic activity of at least 0.075 mmol/h/m².

16. The process as defined by claim 9, further comprising at least one oxide of a fourth element M′ selected from among the rare earth metals other than cerium.
